(19) United States
(12) Patent Application Publication
(10) Pub. No.: US 2024/0240664 A1
(43) Pub. Date: Jul. 18, 2024

(54) SECURING NUT COMPRISING A SPRING-ACCUMULATOR SHAPED COLLAR

(71) Applicant: SF HANDELS- UND BESITZGESELLSCHAFT MBH, Aldingen (DE)

(72) Inventor: Hartmut Flaig, Aldingen (DE)

(73) Assignee: SF HANDELS- UND BESITZGESELLSCHAFT MBH, Aldingen (DE)

(21) Appl. No.: 18/290,100

(22) PCT Filed: May 5, 2022
(86) PCT No.: PCT/EP2022/062204

§ 371 Date: Nov. 9, 2023

(30) Foreign Application Priority Data
May 11, 2021 (DE) 10 2021 112 290.2

(51) Int. Cl. F16B 39/38

(52) U.S. Cl. CPC F16B 39/38

(57) ABSTRACT

A securing nut (20) includes a shaped collar (8) disposed on an end surface (3) of a nut body (1) and integrally connected to the nut body (1), the shaped collar (8) having an inner end surface (11) concentric with an internally threaded hole (9) of the nut body (1), the inner end surface (11) having a distance from the internally threaded hole (9) in an axial direction (A) and having a securing female thread (22) offset from a female thread (23) of the internally threaded hole (9). The shaped collar (8) forms an undercut portion (17) on a radial outer side (16) of the shaped collar (8) adjacent to the end surface (3) in the axial direction (A).

### BACKGROUND OF THE INVENTION

The present invention relates to a securing nut.

Various securing nuts comprising a shaped collar or a securing collar integrally formed on a nut body and leading to self-securing or self-locking by causing or forming a clamping between the nut body and the shaped collar or the securing collar when a screw bolt is screwed in are known from the prior art.

For this purpose, a securing thread is formed in a shaped collar, which is axially spaced apart from an internally threaded hole of the nut body by a slot or a recess, in particular on the inner end surface of the shaped collar, the securing thread being provided with a certain offset from the female thread of the internally threaded hole of the nut body. When the screw is screwed into the securing thread and the female thread, the offset of the threads from each other and the axial deformability of the shaped collar cause a clamping effect or a braking torque on the part of the screw or screw bolt, thus enabling the screw or screw bolt to be secured.

Such approaches are known from WO 2007/076968 A1 and WO 2010/034324 A1 of the applicant, for example.

U.S. Pat. No. 2,376,927 A relates to a securing nut comprising an integrally formed shaped collar; however, the shaped collar as a whole is wider or has a larger diameter than the rest of the nut body. The proposed construction is not very stable.

U.S. Pat. No. 2,551,102 A relates to a securing nut comprising a nut body and a shaped collar integrally formed thereon, openings uniformly distributed across the circumference being formed in the shaped collar by introducing, in particular punching, openings into the shaped collar in the axial direction.

U.S. Pat. No. 2,320,785 A also relates to a securing nut which provides a shaped collar adjacent to the nut body and formed integrally with the nut body. The shaped collar is made from a ring collar in a known manner.

Other securing nuts are known from JPS60-132 116 A and DE 10 2011 052 266 A1, for example.

Securing nuts according to the preamble of claim 1 are known from DE 7313 639 C and U.S. Pat. No. 2,260,531 A.

For many areas of application of such securing nuts, however, it is particularly desirable that the braking torque exerted on the screw or screw bolt is identical or is generated or defined within a narrow tolerance range. In this context, however, the respective manufacturing tolerances of the screw bolts and the securing nuts is an unpredictable or unplannable influencing variable, which in turn contradicts or counteracts an exact definition or an exact predetermination of the braking torque generated in each case.

### SUMMARY OF THE INVENTION

Hence, the object of the present invention is to propose a securing nut in which the braking torque exerted on a screw or a screw bolt in each case can be better predetermined and, in particular, depends less on manufacturing tolerances on the part of the screw bolt and/or on the part of the securing nut.

This object is attained with the features disclosed herein. Advantageous embodiments are disclosed herein and/or are the subject of the dependent claims and the following claim support and figure description.

The securing nut provides a shaped collar disposed on an end surface of a nut body and integrally connected to the nut body, the shaped collar having an inner end surface concentric with an internally threaded hole of the nut body, the inner end surface having a distance from the internally threaded hole in an axial direction and having a securing thread offset, in particular angularly offset, from a female thread of the internally threaded hole. Furthermore, the shaped collar forms an undercut portion on a radial outer side of the shaped collar adjacent to the end surface of the nut body in the axial direction.

In other words, an undercut portion is formed on the radially outer side of the shaped collar between the end surface of the nut body and the shaped collar in an area of transition or in a portion of the shaped collar adjacent to the end surface. This has the effect that when the shaped collar is realized with greater elasticity or a greater spring effect on an axial tensile stress, as when a screw bolt is screwed in, the effect of a spring accumulator can be better realized by the shaped collar with the result that when the screw bolt is screwed in, the braking torque approaches a final value or limit value independently of any manufacturing tolerances of the securing nut and the screw bolt, meaning a large part of the total braking torque generated is already generated in the shaped collar at the beginning of screwing in the screw bolt and further screwing in does not increase the braking torque or increases it only insignificantly.

In this context, the fact is utilized that precisely an undercut on the radially outer side in the area of the shaped collar that comes closest to the end surface of the nut body effects or facilitates the said and desired functionality of a spring accumulator of the shaped collar in a particularly advantageous manner.

According to the invention, the shaped collar forms a curved portion on a radial outer side, preferably adjacent to an outer surface which preferably runs parallel to the end surface of the nut body and forms the end of the shaped collar facing away from the nut body, the curved portion having a circular or elliptical contour. It has been found that the curved portion, especially in conjunction with the undercut portion, enables a particularly advantageous, desirable spring characteristic of the shaped collar. In an advantageous embodiment, the curved portion may additionally end directly or seamlessly in the undercut portion in the axial direction. In a particularly preferred embodiment, the curvature may be essentially constant in the transition from the curved portion into the undercut portion.

According to the invention, the undercut portion and/or the curved portion are formed in sections or are interrupted in a circumferential direction. If an undercut portion and a curved portion are provided, the undercut portion and the curved portion may preferably be formed in the same or corresponding areas, in particular angular areas, in the circumferential direction. By forming the undercut portion and/or the curved portion in sections, the spring characteristic of the shaped collar can be advantageously adapted and influenced in a targeted manner in order to generate the braking torques required or desired depending on the field of application while ensuring or setting the predictability or the upper limit of the braking torques.

According to a likewise advantageous embodiment of the securing nut, the shaped collar may form a stepped portion on a radial outer side, preferably adjacent to an outer surface and/or a curved portion, the stepped portion preferably extending increasingly in the axial direction as it approaches the outer surface preferably in the axial direction. The stepped portion can preferably be provided together with the undercut portion and the curved portion. The stepped portion advantageously enables sufficient material thickness of the shaped collar on a radial inner surface or inner end surface for forming the securing thread. At the same time, the stepped portion enables the rest of the shaped collar, in particular the radial outer side of the shaped collar, to be formed with a shape that further improves the elastic properties and thus the securing effect since the braking torques when screwing in a screw or screw bolt are essentially limited and can thus be reproduced well even in the case of manufacturing tolerances. Realizing the stepped portion also makes it possible in a particularly advantageous manner for the shaped collar to be designed with an approximately constant material thickness in the area of the curved portion and/or in the area of the undercut portion. This configuration of the shaped collar also additionally improves the desired effect of the shaped collar as a spring accumulator.

According to a preferred embodiment, portions having an undercut portion and/or a curved portion alternate, in the circumferential direction, with portions of the shaped collar having a reduced wall thickness. The wall thickness reduced in sections in the circumferential direction can once more influence the deformation and clamping properties of the shaped collar and thus be used to set the desired braking torques. With an alternating arrangement of portions having a reduced wall thickness and portions having an undercut portion and/or a curved portion, both a preferred symmetry and thus a symmetrical effect of the shaped collar can be provided. At the same time, the necessary stability of the shaped collar can also be ensured since the portions or areas having a reduced wall thickness also influence, in particular reduce, the stability of the shaped collar itself and also the stability of the connection between the shaped collar and the nut body.

According to another particularly advantageous embodiment, in the circumferential direction, undercut portions or remaining undercuts may also be formed in areas having a reduced wall thickness. This can be particularly advantageous if the wall thickness is only slightly reduced. In this case, the undercut portion or at least the remaining undercut is continuous or uninterrupted in the circumferential direction.

According to another particularly advantageous embodiment of the securing nut, the portions of the shaped collar having a reduced wall thickness may enclose slots in the shaped collar, in particular slots forming radial openings in the shaped collar, whose longitudinal direction or longitudinal dimension runs parallel to the end surface of the nut body. These slots are formed, for example, centrally within the portions of the shaped collar having a reduced wall thickness if the wall thickness of the shaped collar is reduced to zero in certain areas or portions in the radial direction. When the wall thickness of the shaped collar is reduced to varying degrees in the circumferential direction, said slots are then formed in certain areas, which are then surrounded by said areas of reduced wall thickness in adjacent areas where the wall thickness has been reduced to a lesser degree. The formation of the slots within and/or enclosed by portions of the shaped collar having a reduced wall thickness contributes to the modification and adjustment of the spring properties of the shaped collar and thus to the adjustment or predetermination of the braking torques of the securing thread, as do the portions of reduced wall thickness.

In another particularly advantageous embodiment of the securing nut, the portions of the shaped collar having a reduced wall thickness may be plane and run in the axial direction on the radial outer side of the shaped collar. This configuration has various advantages. First of all, the plane flattening of the shaped collar on the radial outer side of the shaped collar for forming the areas of reduced wall thickness results in a varying reduction in wall thickness in the circumferential direction rather than a constant one. This in turn provides a good balance between the need to adjust the spring properties of the shaped collar on the one hand and the need to stabilize or maintain the stability of the shaped collar on the other. Furthermore, the plane or rectilinear flattening of the shaped collar on the radial outer side results in the fact that when approaching the center of the securing groove, namely the center of the threads, said slots can be formed, which in turn are surrounded or enclosed by the areas of reduced wall thickness.

In another particularly desirable configuration of the securing groove, portions of the shaped collar having a reduced wall thickness are evenly distributed across the circumference. This means that the portions of the shaped collar having a reduced wall thickness extend across an equal angular range, which is a corresponding fraction of 360°.

When divided into an even number of portions of the shaped collar having a reduced wall thickness, this advantageously results in opposite portions on the radial outer side of the shaped collar which are formed parallel to each other in pairs. This permits simple and efficient production or formation of the areas of the shaped collar having a reduced wall thickness.

The braking torque exerted on a bolt or a screw can be adjusted by choosing the number and the reduction of the wall thickness in said portions accordingly.

Furthermore, the shaped collar may advantageously be formed by reshaping a ring collar, preferably by cold forming or cold extrusion.

Alternatively, the shaped collar may advantageously be formed by machining.

Mixed forms of the above embodiment are also conceivable. For example, cold forming or cold extrusion may essentially form or be responsible for the radially inner shape or geometry of the shaped collar, whereas the radially outer shape or the radial outer side of the shaped collar, in particular in the undercut portion, the curved portion and/or the stepped portion, may be formed as a result of machining.

Advantageously, the shaped collar may have a plane, in particular recess-free, outer and/or inner surface across the entire circumference, at least adjacent to the inner end surface. This advantageously allows sufficient area or surface for the formation of the securing thread.

### BRIEF DESCRIPTION OF THE DRAWINGS

Hereinafter, the invention will be explained based on purely schematic illustrations showing exemplary embodiments.

FIG. 1 shows a simulation of a securing nut (ot part of the invention) at a stage before the thread and the securing thread are created;

FIG. 2: is a section through a first embodiment of a generic securing nut;

FIG. 3: is a side view of first embodiment of a securing nut according to the invention;

FIG. 4: is a perspective view of the first embodiment of a securing nut according to the invention;

FIG. 5a: is a schematic section through a second embodiment of a securing nut according to the invention;

FIG. 5b: is a schematic side view of a second embodiment of a securing nut according to the invention;

FIG. 5c: is a partially cut schematic perspective view of a second embodiment of a securing nut according to the invention;

FIG. 6a: is a schematic section through a second embodiment of a generic securing nut;

FIG. 6b: is a schematic side view of a second embodiment of a generic securing nut;

FIG. 6c: is a partially cut schematic perspective view of a second embodiment of a generic securing nut.

### DETAILED DESCRIPTION

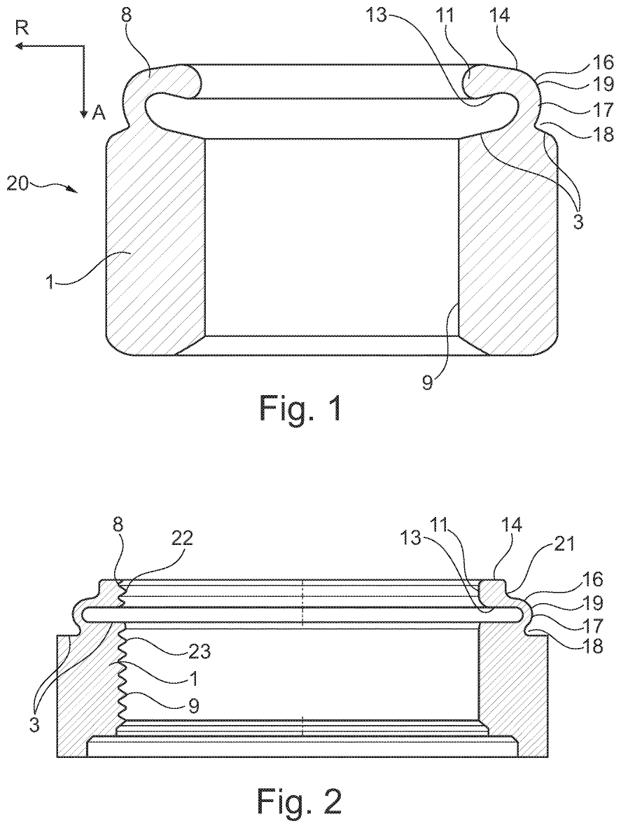

FIG. 1 shows a simulation of a securing nut 20 in a sectional view. As can be seen in FIG. 1, a shaped collar 8 is integrally formed on the nut body 1. The shaped collar 8 forms an undercut portion 17 on a radial outer side 16, the undercut portion 17 leading to the formation of an undercut 18 in the axial direction A in a transition between the end surface 3 of the nut body 1 and the shaped collar 8. This undercut 18 or the associated undercut portion 17 of the shaped collar 8 significantly improves the properties, in particular the spring action, of the shaped collar 8.

The undercut portion 17 can be achieved either by tolerating or even provoking a certain degree of bulging in the radial direction R during an axial reshaping of a ring collar to form the shaped collar 8. Alternatively, the undercut portion 17 can also be produced by machining the shaped collar 8. Even if the simulation of FIG. 1 suggests a certain unevenness in the inner surface 13 or the outer surface 14 of the shaped collar 8, this unevenness is not present in the actual component. Instead, it is achieved according to an advantageous embodiment that the inner surface 13 or the outer surface 14 are plane, recess-free surfaces, which thereby enable advantageous accommodation or formation of a securing thread on the inner end surface 11. The inner end surface 11 of the shaped collar 8 and the internally threaded hole 9 of the nut body 1 are still shown without corresponding threads in the exemplary illustration or simulation illustration of FIG. 1. The basic securing function of the securing nut 20 is achieved by introducing the respective threads with an offset or angular offset from one another. After all, when a screw bolt or another type of screw having an external thread is screwed into the securing thread of the shaped collar 8 and the female thread of the nut body 1, clamping is achieved between the securing nut 20 and the screw bolt, which generates a braking torque on the screw bolt and thus enables self-locking or self-securing of the screw bolt.

The design of the undercut portion 17 means that the braking torques acting on the screw bolt are less or hardly dependent on production-related deviations or tolerances on the part of the securing nut or the screw bolt. Instead, the undercut portion 17 enables the braking torque to increase relatively quickly to a desired value or a target value when the screw bolt is screwed in and to increase no further or only insignificantly during further screwing. The braking torques can be defined or set by various measures, as will be described below with reference to the other embodiments.

The shaped collar 8 according to FIG. 1 also shows a curved portion 19 adjacent to the undercut portion 17 on the radial outer side, the curved portion 19 having a circular or elliptical shape or contour. This shape on the radial outer side 16 of the shaped collar 8 also improves the properties, in particular the spring properties, of the shaped collar 8 and thus improves the reproducible securing effect of the securing nut 20.

FIG. 2 shows a section through an advantageous configuration of a generic securing nut 20. In addition to an undercut portion 17 and a curved portion 19, the securing nut 20 has a stepped portion 21, which is preferably disposed or formed between the outer surface 14 and the curved portion 19. On the one hand, the stepped portion 21 enables a sufficient thickness of the shaped collar 8 in the radial direction R to be present in the upper area of the shaped collar 8 in the vicinity of or adjacent to the outer surface 1 in order to support the securing thread 22. At the same time, however, the stepped portion 21 also enables the shaped collar 8 to have an essentially constant and preferably relatively low thickness in a central and lower area of the shaped collar 8, preferably in the area of the curved portion 19 and the undercut portion 17, which benefits the spring properties of the shaped collar 8. The stepped portion 21 can be formed both by cold forming or cold working and by machining. In FIG. 2, the female thread 23 of the internally threaded hole 9 is shown in addition to the securing thread or securing female thread 22. Threads 23 and 22 are offset from each other, in particular twisted or rotated at an angle relative to each other, in such a manner that when a threaded bolt is screwed into the securing nut 20, the shaped collar 8 is elastically deformed with the result that clamping between the nut body 1 and the shaped collar 8 causes the threaded screw bolt to be secured or self-secured.

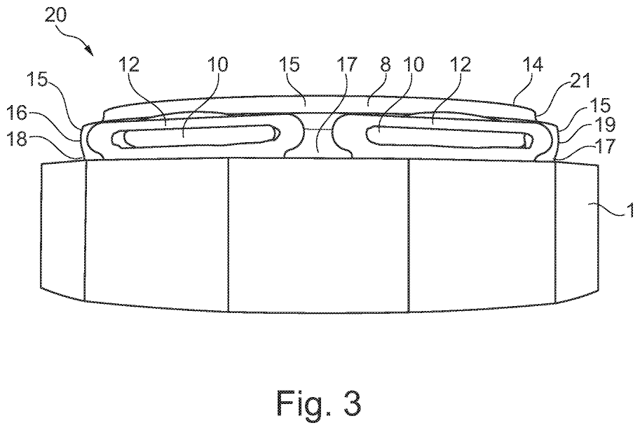

FIG. 3 shows a side view of a securing nut 20 according to the invention. In FIG. 3, it can be seen that the shaped collar 8 has, in addition to a stepped portion 21, first portions 15 with an undercut portion 17 and a curved portion 19 and second portions 12 with a reduced wall thickness of the shaped collar 8 alternating in a circumferential direction. The second portions 12 of the shaped collar 8 having a reduced wall thickness have such a reduced wall thickness that the reduction of the wall thickness is so pronounced centrally or internally in the portions 12 having a reduced wall thickness that slots 10 are formed in the shaped collar 8, which extend from the radial outer side 16 into the radially inner gap between the internally threaded hole 9 and the inner end surface 11. The portions 12 of the shaped collar 8 having a reduced wall thickness allow the spring action of the shaped collar 8 to be set or changed and thus also have an influence on the generation of the braking torque acting on a screw bolt. The areas 15 which have the undercut portion 17 and the curved portion 19 also contribute to the advantageous spring action of the shaped collar 8 and additionally stabilize the connection between the nut body 1 and the shaped collar 8.

In the perspective view of FIG. 4, it can be seen that part of the curved portion 19 and the undercut portion 17 still remains in the outer or edge areas in the portions 12 having a reduced wall thickness. In the central areas, in particular in the areas where the slots 10 are formed, no curved portion 19 and no undercut portion 17 is formed. FIG. 4 also shows the female threads 23 and 22. Furthermore, it can be seen that the portions 12 having a reduced wall thickness are formed on both sides of the internally threaded hole 9 and opposite portions 12 having a reduced wall thickness run parallel to each other. Similarly, it can be seen from FIG. 4 that the radial outer side 16 of the shaped collar 8 in portions 12 having a reduced wall thickness are plane and extend in the axial direction A. This allows, for example, that the portions 12 having a reduced wall thickness are formed by later material removal of the shaped collar 8, as shown, for example, in FIG. 2.

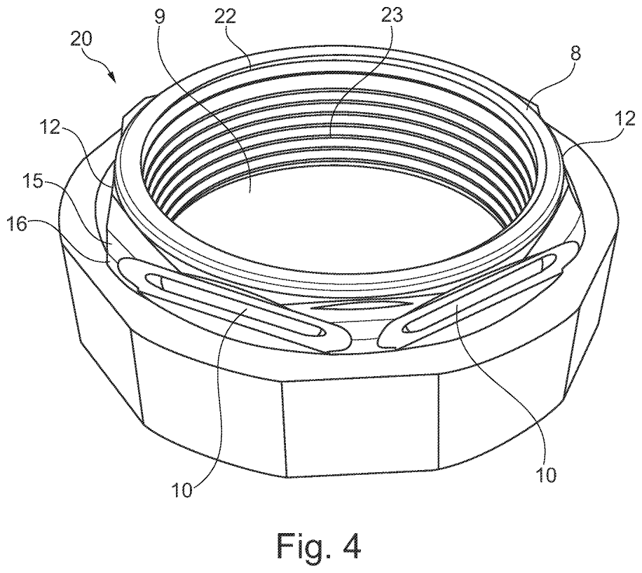

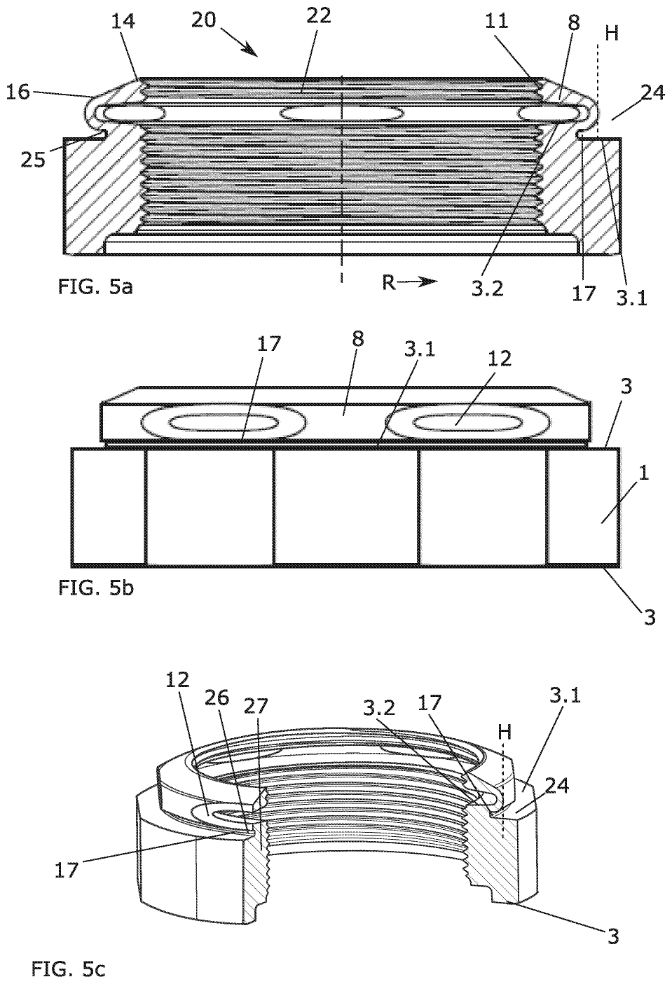

The illustration of FIG. 5a shows another embodiment of a securing nut 20 according to the invention. The embodiment has similarities or overlaps with the embodiment of FIGS. 3 and 4. As can be seen from FIG. 5a, in contrast to the embodiment of FIGS. 3 and 4, the securing nut 20 of FIG. 5a does not have a stepped portion 21. Instead, the shaped collar 8 is formed in such a manner that the thickness or width of the shaped collar 8 increases as it approaches the outer surface 14 and as it approaches the securing thread 22, but without forming a corresponding step or stepped portion 21. The continuous increase in the thickness of the shaped collar radially inwards towards the securing thread 22 has the advantage that sufficient material or a sufficient material thickness in the axial direction is formed on the inner end surface 11 to provide a securing thread 22 with a sufficiently large number of turns or with a sufficiently large portion of turns. The relatively complex formation of the stepped portion can be dispensed with. If necessary, it is even possible to form the wall thickness of the shaped collar which increases in the radially inward direction with increasing axial distance merely by reshaping a ring collar with a correspondingly increasing wall thickness in the axial direction without machining the shaped collar.

The terminology and the technical meaning of the undercut portion 17 shall also be explained once again based on the illustration in FIG. 5a.

In the exemplary embodiment of FIG. 5a, the end surface 3 is essentially horizontal or plane in the radial direction and parallel to the radial direction. The end surface 3 points away from the nut body 1. Adjacent to the end surface 3 in the axial direction A and with increasing distance from the nut body 1, there are two different radially adjoining areas, which are separated from each other by a reference line H in the illustration of FIG. 5a. In particular, this relates to a radially outer part 3.1 of the end surface 3. The undercut portion 17, which is formed radially inward with respect to the reference line H, is located in a radially inner area. On the radially outer side of the reference line H, a protruding portion 24 adjoins the end surface 3 in the axial direction A with increasing distance from the nut body. As can be seen from FIG. 5a, the reference line H runs parallel to the axial direction A through the radially outermost point of the radial outer side 16 of the shaped collar 8.

The wording according to which the shaped collar 8 forms an undercut portion 17 on a radial outer side 16 of the shaped collar 8 adjacent to the end surface 3 in the axial direction A is accordingly intended to encompass embodiments in which the radially outer end surface 3.1 exists since otherwise there is no end surface available from which the radially outer side or the radial outer side of the shaped collar can form an undercut portion 17 in the axial direction in the first place. Furthermore, the above formulation is to be understood just in such a manner that the undercut portion 17 is the very portion or area in the radially inner area of the reference line H. In other words, this means that the undercut portion 17 in the illustration of FIG. 5a is defined by a portion of the radially outer end surface 3.1, the shaped collar 8 and the reference line H.

FIG. 5a further shows an advantageous embodiment in which the undercut portion 17 has a base portion 25 adjacent to the end surface 3 in the axial direction, the base portion 25 extending in the axial direction axially parallel to the axial direction A across a certain length. The undercut portion 17 has a base portion 25 which extends over a certain length in the axial direction axially parallel to the axial direction A. An undercut portion with such a rectilinear base portion 25 of the area lying furthest inward in the radial direction R permits in a particularly advantageous manner a later production or reworking, in particular machining, of the undercut portion 17.

In the side view of FIG. 5b, it becomes clear once again what the present disclosure would like to be understood as end face 3. With respect to the nut body 1, there are two end faces 3 at opposite ends of the nut body 1 in the axial direction A. The end face 3 facing the shaped collar, which contributes to the delimitation of the undercut portion 17 on a radially outer portion, namely end face 3.1, has another portion 3.2 on a radially inner side of the nut body 1, as can be seen in the sectional view of FIG. 5a, portion 3.2 being disposed further up or closer to the shaped collar 8 in the axial direction than the end surface 3.1 lying on the outside in the radial direction R.

In FIG. 5b, portions 12 of the shaped collar 8 having a reduced wall thickness can also be seen; compared to the illustrations of FIGS. 3 and 4, the illustration of FIG. 5b shows that an undercut portion 17 also remains in the portions 12 having a reduced wall thickness in the axial direction between the end surface 3.1 and the shaped collar 8.

This remaining undercut 26 can also be seen, for example, in FIG. 5c in the area of the left cut face 27 below a portion 12 having a reduced wall thickness. In the embodiment of FIGS. 5a to 5c, the undercut portion 17 or at least the remaining undercut 26 of the undercut portion 17 is thus radially circumferential and uninterrupted. This embodiment permits a simple machining or reworking of the undercut portion 17 in a particularly advantageous manner, in particular in connection with the end surfaces 3, 3.1, which are plane in the radial direction R and run parallel to the radial direction.

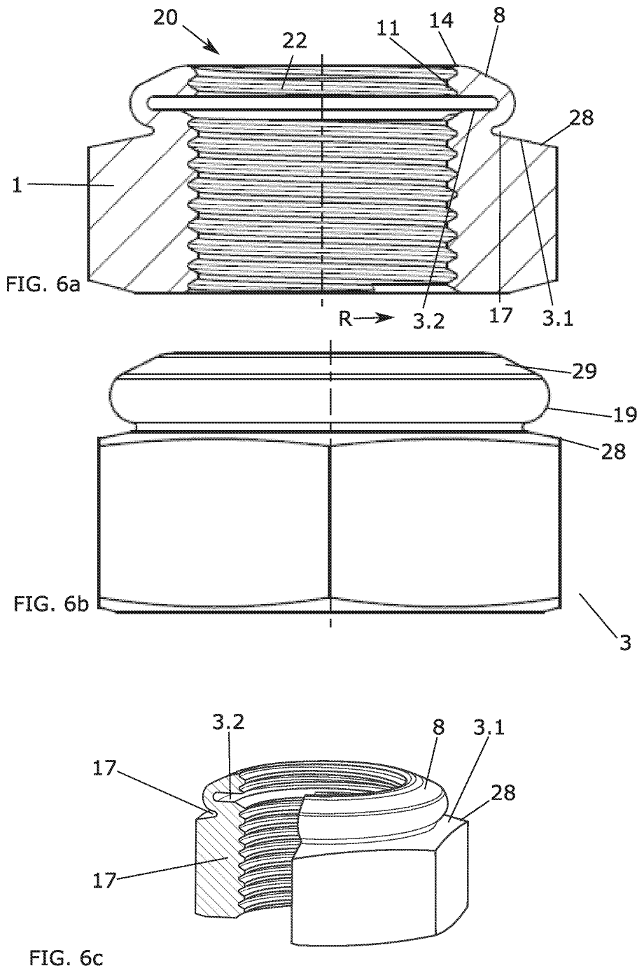

FIGS. 6a to 6c have in common with the embodiment of FIGS. 5a to 5c that no stepped portion 21 is formed, either; instead, the shaped collar 8 increases continuously with axial distance from the end surface 3 and with increasing proximity to the inner end surface 11 for forming the securing thread 22 in order to be able to provide a sufficiently wide or high surface in the axial direction A for forming the securing thread 22. In contrast to the embodiment of FIGS. 5a to 5c, the securing nut 20 of the embodiment of FIGS. 6a to 6c does not have portions having a reduced wall thickness in the shaped collar. Furthermore, the radially outer end surface 3.1 is plane but does not run parallel to the radial direction R; instead, it slopes radially outward in the form of a shoulder 28.

The radially inner portion 3.2 of the end surface 3, on the other hand, runs at a higher level than the end surface 3.1, parallel to the radial direction R.

In the embodiment of FIGS. 6a to 6c, as shown, the portion of the undercut portion 17 lying furthest inward in the radial direction R also does not extend parallel to axial direction A across any significant area but is rather continuously curved starting from the inclined shoulder 28.

Starting from the inclined shoulder 28, the undercut portion 17 can also be formed particularly easily and effectively in this embodiment.

As in the embodiment of FIGS. 5a to 5c, the outer surface 14 is relatively small or formed as a relatively thin annular disc and ends directly in an upper shoulder portion 29 of the shaped collar 8 which is inclined radially outwardly with respect to the radial direction R and which in turn merges into a curved portion 19 with the result that the increasing thickness or increasing height of the shaped collar 8 is formed in the interior of the shaped collar 8, in particular by the upper shoulder portion 29, as it approaches the inner end surface 11.

As stated previously, this embodiment of the radial outer side of the shaped collar has in particular manufacturing-related advantages. It can also have a positive effect on the spring properties of the shaped collar.

### REFERENCE SIGNS

1 nut body
3 end surface
8 shaped collar
9 internally threaded hole
10 slot
11 inner end surface
12 second portions
13 inner surface
14 outer surface
15 first portions
16 outer side
17 undercut portion
19 curved portion
20 securing nut
21 stepped portion
22 securing thread
23 female thread
24 protruding portion
25 base portion
26 remaining undercut
27 cut face
28 shoulder
29 shoulder portion
A axial direction
R radial direction
H reference line

1. A securing nut (20) comprising a shaped collar (8) disposed on an end surface (3) of a nut body (1) and integrally connected to the nut body (1), the shaped collar (8) having an inner end surface (11) concentric with an internally threaded hole (9) of the nut body (1), the inner end surface (11) having a distance from the internally threaded hole (9) in an axial direction (A) and having a securing female thread (22) offset from a female thread (23) of the internally threaded hole (9), the shaped collar (8) forming an undercut portion (17) adjacent to the end surface (3) in the axial direction (A) on a radial outer side (16) of the shaped collar (8), the shaped collar (8) forming a curved portion (19) on a radial outer side (16), the curved portion (19) having a circular or elliptical contour,
wherein
the undercut portion (17) and/or the curved portion (19) is formed in sections in a circumferential direction.

2. The securing nut according to claim 1, wherein
the shaped collar (8) forms a stepped portion (21) on a radial outer side (16) and/or a curved portion (19), the stepped portion (21) extending increasingly in the axial direction as it approaches the outer surface (14) in the axial direction (A).

3. The securing nut according to claim 2, wherein
in the circumferential direction, portions (15) having the undercut portion (17) and/or the curved portion (19) alternate with portions (12) of the shaped collar (8) that have a reduced wall thickness.

4. The securing nut according to claim 3, wherein
the portions (12) of the shaped collar (8) that have a reduced wall thickness enclose slots (10) in the shaped collar (8), the slots (10) running parallel to the end surface (3).

5. The securing nut according to claim 3,
wherein
the portions (12) of the shaped collar (8) that have a reduced wall thickness are plane and run in the axial direction (A) on the radial outer side (16) of the shaped collar (8).

6. The securing nut according to claim 3,
wherein
portions (12) of the shaped collar (8) that have a reduced wall thickness are distributed evenly across the circumference on the radial outer side (16) of the shaped collar (8).

7. The securing nut according to claim 1,
wherein
the shaped collar (8) is formed by reshaping a ring collar.

8. The securing nut according to claim 1,
wherein
the shaped collar (8) is formed by machining.

9. The securing nut according to claim 1,
wherein
the shaped collar (8) has an outer and/or inner surface (13, 14) which is plane across the entire circumference at least adjacent to the inner end surface (11).

10. (canceled)

11. (canceled)

12. The securing nut according to claim 1, wherein the curved portion (19) is adjacent to an outer surface (14).

13. The securing nut according to claim 2, wherein the stepped portion (21) is adjacent to an outer surface (14).

14. The securing nut according to claim 9, wherein the outer and/or inner surface (13, 14) is free from recesses.
